(19) United States
(12) Patent Application Publication
(10) Pub. No.: US 2009/0165062 A1
(43) Pub. Date: Jun. 25, 2009

(54) System and Method for Reducing Latency Using a Sample Channel

(75) Inventors: John Harris, Glenview, IL (US); Hua Xu, Lake Zurich, IL (US)

Correspondence Address: Motorola, Inc.;Law Department, 1303 East Algonquin Road, 3rd Floor, Schaumburg, IL, 60196, US

(73) Assignee: MOTOROLA, INC., SCHAUMBURG, IL (US)

(21) Appl. No.: 11/963,168

(22) Filed: Dec. 21, 2007

(51) Int. Cl. H04N 7/173

(52) U.S. Cl. 725/87

(57) ABSTRACT

A system and method reduce latency involved in delivery of content to a handheld device. A sample channel comprises a plurality of content segments. Each content segment comprises recent content from one channel of a plurality of channels available for request by a subscriber. The sample channel is received by a handheld device and is not requested by the subscriber. The plurality of content segments are stored in a memory associated with the device. Upon detecting a request from the subscriber to view a specified channel, the content segment corresponding to the specified channel is located in memory and displayed on the device. A request is made for subsequent content from the specified channel, the subsequent content starting at or before the end of the content segment. Playback of the subsequent content is then initiated such that the subsequent content starts at a time when the content segment ends.

### BACKGROUND

1. Field

This disclosure relates to reducing latency in providing content to handheld devices, and more particularly to reducing latency in providing television content to a mobile device.

2. General Background

Handheld or mobile devices such as mobile telephones are now capable of receiving video and audio content such as television broadcasts. However, there are problems associated with viewing television content on a mobile phone, such as delays which often occur in requesting and receiving a television channel over a cellular network.

For example, when a television channel is requested for viewing by a subscriber of a mobile phone, there is often a substantial delay that occurs before the video is actually displayed. The delay may be caused by the time taken for the mobile phone to transmit a message requesting to view a channel, to establish a connection with the requested channel, and/or to store enough data in the memory buffer such that an un-interrupted display of video may occur. Furthermore, each time a new channel is received, the content generally starts with a full Intra frame (“I-frame”) so that the mobile device can decode and view the channel. I-frames are typically larger than other frames received, which are differential frames, and can take longer to transmit and decode. There may also be occasional networking or server delays which occur. This delay may occur initially at startup of the television application. The delay can also occur each time the subscriber requests to change the channel. Such delays adversely affect a user's viewing experience.

### DRAWINGS

The above-mentioned features of the present disclosure will become more apparent with reference to the following description taken in conjunction with the accompanying drawings wherein like reference numerals denote like elements and in which:

FIG. 1 is a block flow diagram of a method for reducing latency in content delivery to a handheld device in accordance with one aspect of the present disclosure.

FIG. 2 illustrates an example of one implementation for reducing latency in content delivery by using a sample channel.

FIG. 3 illustrates an example of one implementation for reducing latency in content delivery by using a sample channel and a catch up channel.

FIG. 4 illustrates an implementation wherein two handheld devices can be synchronized to use a single data stream.

FIG. 5 illustrates an implementation where two sample channels are utilized to implement a scan function.

FIG. 6 illustrates an apparatus 600 to which latency of content delivery is reduced.

### DETAILED DESCRIPTION

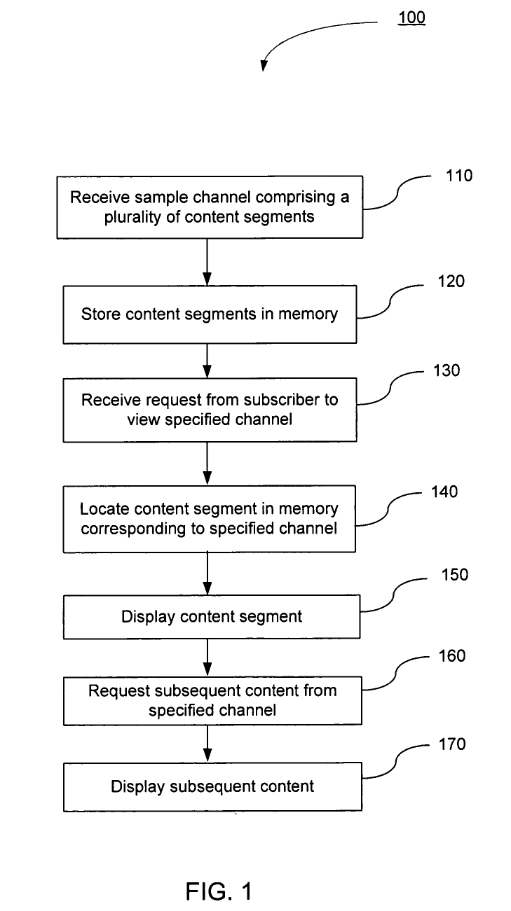

A system and method for reducing latency involved in delivery of content to a handheld device is disclosed. FIG. 1 is a block flow diagram illustrating a method for reducing latency in content delivery to a handheld device in accordance with one aspect of the present disclosure.

A sample channel is provided comprising a plurality of content segments. Each content segment comprises recent content from one channel of a plurality of channels available for request by a subscriber. The sample channel is received by a handheld device, as indicated at block 110. The channel and/or the sample channel may adhere to any communications standard such as a wireless standard (e.g., Orthogonal Frequency Division Multiplexing (OFDM), Code-Division Multiple Access (CDMA), or Microwave Access (WiMAX)). Further, if the sample channel is received by a fixed device such as a set-top box (“STB”), a conventional standard (e.g., twisted pair, fiber, or satellite) may be utilized. In one implementation, the sample channel is received by the device and other devices, and is not requested by any of the devices by the subscriber. At block 120, the content segments as received through the sample channel are stored in a memory associated with the device.

A request is received at the device from a subscriber to view a specified channel, as indicated at block 130. Upon detecting the request from the subscriber to view one of the plurality of channels, the content segment corresponding to the requested channel is located in memory as indicated at block 140. The content segment corresponding to the specified channel is displayed on the device, as indicated at block 150. A connection is initiated with the specified channel for subsequent content. Therefore, as indicated at block 160, a request is made for subsequent content. The subsequent content starts at or before the end of the content segment. Once the connection with the requested channel has been established and the subsequent content is received, playback of the subsequent content can be initiated. Display of the content is indicated at block 170. Playback is initiated such that the subsequent content starts at a time when the content segment ends. In one implementation, the subsequent content starts at or before the end of the content segment. Therefore, the subscriber views a continuous and uninterrupted display of content.

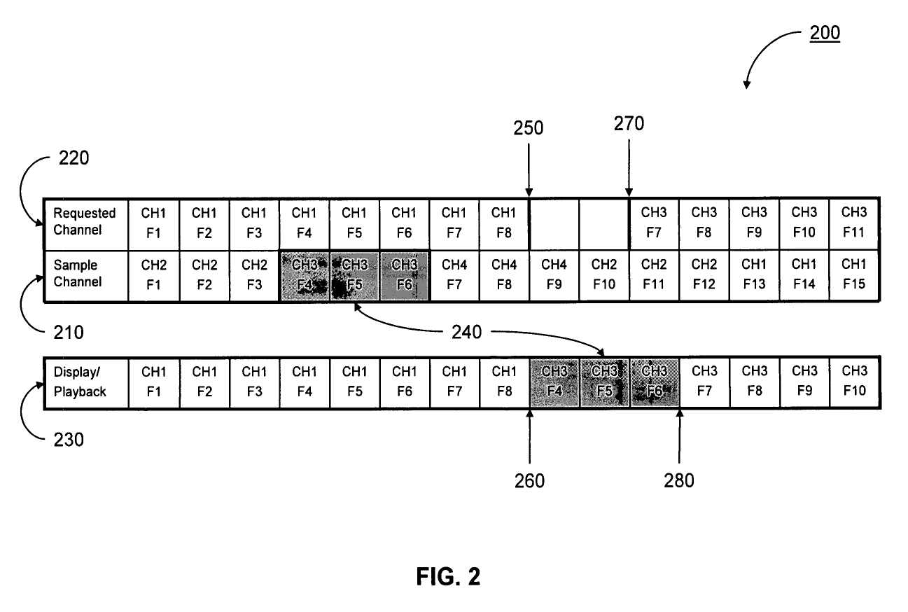

The system and method of reducing latency in a content delivery system is now described in more detail with reference to FIG. 2. FIG. 2 illustrates an example wherein a handheld device receives a plurality of content segments through a sample channel in order to improve a subscriber experience.

In one aspect, the system and method in accordance with the present disclosure is used to improve a user's experience in viewing video such as a television broadcast or unicast on a handheld device such as a mobile telephone. Accordingly, in one implementation, the channels available to the subscriber are television channels, and the content associated with each channel comprises video and/or audio. Further, in one implementation, the service provider may utilize the number of viewers in a given cell as a basis for whether the channel and/or the sample channel are transmitted in a broadcast or unicast manner. For example, if only one user is in a cell, then the service provider may send both the channel and the sample channel through a unicast to that single user. However, if there are multiple users in a cell, the service provider may send the sample channel through a single broadcast signal to the cell rather than multiple unicast feeds. Further, the channel may be broadcasted rather than unicasted to the cell if multiple users are watching the same channel. In an alternative implementation, the service provider establishes a broadcast/unicast method of delivery without consideration to the number of users in a given cell.

An example of content transmitted by a sample channel is shown in the row of cells 210. As discussed earlier, sample channel 210 transmits a plurality of content segments. Each content segment comprises recent content from one of a plurality of channels available to the subscriber. More particularly, the sample channel transmits at least one content segment for each of the plurality of channels available. For example, if there are ten television channels available to a subscriber for viewing, the sample channel transmits a series of ten content segments, one content segment corresponding to each of the ten television channels, and each content segment comprising recent video and/or audio from the corresponding television channel. In one aspect, the series is repeated over time, with each subsequent series comprising more recent content segments from each of the television channels. For example, a second series of ten content segments would follow the first series mentioned above, the content segments from the second series comprising newer or more recent content than the first. Therefore, in one aspect, the sample channel comprises a plurality of sets of content segments, each set of content segments comprising one content segment for each channel of the plurality of channels. Each set represents content for a specific time interval.

In one aspect, the content comprises compressed video, and each content segment comprises a plurality of video frames. The first frame of the plurality of frames is an I-frame. In video compression, an I-frame is a frame in which a complete image is stored in the data stream. Only changes that occur from one frame to the next are stored in the data stream in order to greatly reduce the amount of information that must be stored. This technique capitalizes on the fact that most video sources (such as a typical movie) have only small changes in the image from one frame to the next. Whenever a drastic change to the image occurs, such as when switching from one camera shot to another, or at a scene change, an I-frame is created. The entire image for the frame is outputted because the visual difference between the two frames is so great that the new image cannot be reproduced incrementally from the previous frame. A scene change is one example of a situation in which an I-frame may be inserted. A typical MPEG video can have an I-frame inserted periodically. For broadcast TV, an I-frame may be inserted every 2-4 seconds. For a user that just switched to a different channel, this may mean having to wait 2-4 seconds to receive the next I-frame in order to start decoding.

In the example shown in FIG. 2, five different content segments are shown as being transmitted in the sample channel 210, each content segment being represented by three cells. Each cell represents a portion of content or data from a specific channel for a specific time interval. In one aspect, each cell represents a video frame. In another aspect, each cell represents a time interval. For example, the cell labeled CH2 F1 represents content from channel two at a time interval F1. Similarly, a first content segment from channel two is indicated by the first three cells labeled CH2 F1, CH2 F2, and CH2 F3. A second content segment, from channel three, is represented by the next three cells labeled CH3 F4, CH3 F5, and CH3 F6. A third content segment from channel four is represented by the following three cells labeled CH4 F7, CH4 F8, and CH4 F9. A fourth content segment comprises content from channel 2, however for time segments F10, F11, and F12. Finally, a fifth time segment for channel one is shown by the three cells labeled CH1 F13, CH1 F14, and CH1 F15.

In one aspect, the sample channel is not requested by the subscriber. That is, the sample channel is received by the device without the request of the subscriber. In one aspect the sample channel is always received by the device. In another aspect, the sample channel may be selectively requested by the device.

Upon receiving the content segments transmitted by the sample channel, the content segments are stored in a memory associated with the device. In one aspect the memory may be a circular memory or buffer such that one content segment per channel is stored in memory at a time, with newer content segments overwriting older content segments. Each time a new content segment is received by the device, the content segment stored in memory corresponding to the same channel is overwritten. For example, the content segment from channel two at time interval F1-F3 is initially stored in memory. When another content segment is received for channel two, it will overwrite the content segment already stored in memory for channel two. Therefore, the content segment from channel two at time interval F1-F3 is later overwritten by the content segment from channel two at time interval F10-F12. In one implementation, a lookup table is utilized to determine a location of the content segment corresponding to the same channel previously stored in memory.

As shown in FIG. 2, content being received by the device from the requested channel is represented by the row of cells indicated at 220. In the example illustrated, the subscriber has initially requested to receive content from channel one. This can be seen by cells labeled “CH1” from F1-F8 in the requested channel row 220. The content being displayed on the device is represented by the row of cells indicated at 230. Because a connection has been established with channel one, the content is displayed on the device in substantial real time with the receipt of the content. Therefore, display row 230 shows the same cells for channel one at time interval F1-F8 as being received and displayed simultaneously.

However, consider that at some point, the subscriber decides to change the channel. For example, as shown in FIG. 2, while viewing channel one the subscriber makes a request to view channel three as is indicated at 250. Upon receiving the request from the subscriber to view channel three, the device locates the most recent content segment having been received by the sample channel and subsequently stored in memory that corresponds to channel three. The content segment relating to channel three is indicated by the block of three cells indicated at 240. Once content segment 240 has been identified in memory, it is displayed on the device. Because content segment 240 is already located in local memory, there should be little to no lag time associated with displaying the content. Therefore, from the subscriber's perspective, content is displayed almost immediately after the request to change the channel was made. As can be seen from the display 230, content segment 240 is now displayed on the device as indicated at 260.

Simultaneously, a connection is initiated by the device with the requested channel, or in this case, channel three. A request is made for subsequent content, the subsequent content starting at or before the end of the content segment, such that a continuous display may be presented to the subscriber. In one implementation, the subsequent content does not include content transmitted for the content segment over the sample channel. In this example, because content segment 240 is for time interval F4-F6, subsequent content starting at time interval F7 is requested. Upon receiving the subsequent content from the requested channel, the subsequent content may be displayed. However, in order to ensure that the content is displayed continuously and without interruption, a proper transition point should be selected.

In one aspect, the subsequent content starts when or where the content segment ends, and there is little to no overlap of content. In this case, the entire length of the content segment may be displayed, followed by the subsequent content starting at the point where the content segment ends. For example, in the example shown, content segment is for time interval F4-F6. Subsequent content is received starting at F7. Therefore, in one aspect the start time of the subsequent content is approximately the same as the end time of the content segment.

In another aspect, there may be overlap between the content segment and the subsequent content. For example, subsequent content may be requested starting at a time prior to the end time of the content segment. In this case, the content segment may be stopped early, and subsequent content then displayed immediately after. In the example of FIG. 1, subsequent content may be requested starting at F6. Therefore there would be overlapping content. The device could either choose to play out the content segment for its entire length, and then start the subsequent content. Alternatively, playback of the content segment could be stopped before the end of the content segment is reached, and the subsequent content displayed starting at the time the content segment was ended.

The content segments can be of any size or length of time. However, in general the length of the content segment should allow for enough time to initiate a connection with a newly requested channel, and to receive the subsequent content. The sample channel 210 illustrated in FIG. 1 is shown as a plurality of content segments, one following immediately after the next. However, in another aspect, the content segments may be transmitted with empty space in between each of the content segments. In one aspect, each content segment comprises a plurality of frames, the first frame being a key frame or an I-frame.

In one aspect, the system and method in accordance with the present disclosure is used to reduce the user's perceived latency in rendering the media such as video and/or audio to handheld devices such as a mobile telephone or a personal digital assistant (PDA) which communicate using a cellular network. Furthermore, as in the example of FIG. 2, communication may be via a packet based network capable of two-way communication, and thereby allowing a request to be made for content starting at a specific point in time. This is different from a traditional television broadcast where the identical content is transmitted to a plurality of subscribers in real time, and no request for data starting at a specific start time, which may be in the past, can be made.

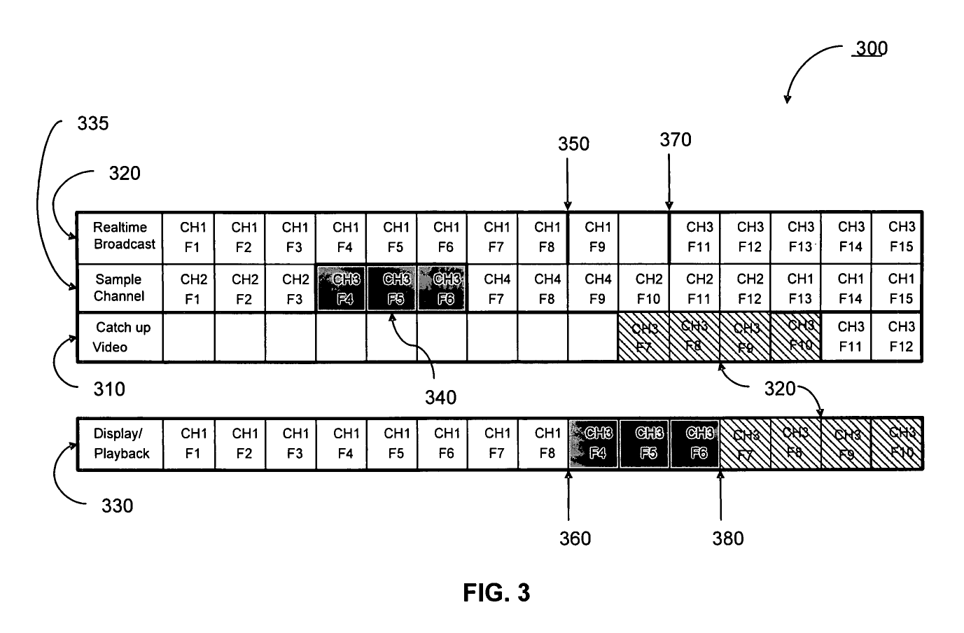

FIG. 3 illustrates a system and method for reducing latency in content delivery to a device in accordance with another implementation of the present disclosure. In the implementation of FIG. 3, an additional channel 310 is used to provide “catch up” content. The catch up content may be provided through an alternative or additional channel, such as an 802.11 wireless network. Furthermore, the catch up content can be used in a system where only a real time and/or one-way broadcast of the content is available.

It is increasingly common that handheld devices such as mobile telephones may have a plurality of different communications means. For example, many mobile telephones have the capability to communicate using wireless data spectra other than the standard cellular network. Further, many mobile phones or PDA's include an IEE 802.11 WiFi transmitter/receiver. This allows the mobile phone to access a wireless LAN if available, as is common in many homes, offices, and public places offering wireless hotspots. A wireless LAN can provide much higher data rates than a traditional cellular network. For example, commonly available protocols 802.11b and 802.11g offer data rates of 11 Mbit/s and 54 Mbit/s, respectively. A cellular data network such as EV-DO affords data rates of only 2-3 Mbit/s. Therefore, if a faster network is available, it should be used.

It should be noted that the communications network used to transmit the broadcast channel and/or the sample channels can be the same or different communications networks or protocols. For example, the communications network can be a next generation cellular system, such as Worldwide Interoperability for WiMAX, Long Term Evolution (LTE), and Ultra Mobile Broadband (UMB). They can also be Digital Video Broadcasting-Handheld (DVB-H), MediaFLO or WiFi. DVB-H is a technical specification for bringing broadcast services to handheld receivers. The channel that is used to transmit the content can be either a unicast channel or a broadcast channel. The systems and networks through which content is transmitted and received, should not be limited by what has been described herein, and can be extended to any communications network.

In FIG. 3, content being received by the device from a real time broadcast is represented by the row of cells indicated at 320. As in the example from FIG. 2, the subscriber has initially requested to receive content from channel one. This can be seen by cells labeled “CH1” from F1-F8 in the real time broadcast row 320. The resultant content being displayed on the device is represented by the row of cells indicated at 330. The content is displayed on the device in substantial real time with the receipt of the content, as the content received is a real time broadcast 320. Therefore, display row 330 shows the same cells for channel one at time interval F1-F8 received and displayed.

However, as indicated at 350, the subscriber makes a request to view channel three. Upon receiving the request from the subscriber to view channel three, the device locates the most recent content segment having been received by the sample channel 335 and subsequently stored in memory that corresponds to channel three. The content segment relating to channel three is indicated by the shaded block of three cells indicated at 340. Once content segment 340 has been identified in memory, it is displayed on the device. Because content segment 340 is already located in local memory, there should be little to no lag time associated with displaying the content. As can be seen from the display 330, content segment 340 is now displayed on the device as indicated at 360.

The device now initiates a connection with requested channel three. However, in this example, because the requested channel is a real time broadcast, a request cannot be made for content starting at a specific point in time prior to present time. Therefore, there will be a missing content gap extending from the end time of the content segment until the time content is received from the requested channel. In the example shown in FIG. 3, the content segment extends from F4-F6. Therefore, catch up content is required starting at F7 and extending until the real time broadcast can be received.

Therefore, in one aspect an alternative communication network can be utilized to fill in the missing content gap, if available. For example, if the device is capable of communicating over a network such as a wireless LAN, a request is made for catch up content, as indicated by the row of cells at 310. Because content segment 340 only covers time interval F4-F6, catch up video is needed starting at F7. Catch up content 320 is therefore shown starting at cell F7. The catch up content may now be displayed, starting where the content segment 340 ends, such that the overall display of the content from channel three appears to be continuous and uninterrupted to the subscriber. Once the real time broadcast from the requested channel is received, and enough catch up content has been received to fill in the gap between the content segment and real time, the device can switch back to displaying the real time broadcast. In the example shown in FIG. 3, the real time broadcast of channel three is established again starting with cell F11, as indicated at 370. Therefore, catch up content should be displayed to cover the gap extending from F7, after the content segment ends, to F10, just before the real time broadcast starts. In one implementation, a buffer it utilized to retrieve the real time frames while the catch up frames are being rendered.

In one aspect, the catch up content is requested starting at or before the end of the content segment 340 already located in memory, and currently being displayed. That is, the catch up content is received through a two way communications network. In another aspect, the catch up content is simply a buffered or delayed broadcast of the requested real time broadcast channel. In other words, the catch up content may simply be a time delayed version of the real-time broadcast. In such an aspect, the catch up content may be broadcast using a one way communications channel. The catch up content may for example be pre-buffered by an edge node, such as a wireless access point or edge router. The catch up video may be accessed by the same network as the one used for broadcast channel and sample channel transmission, or an alternative network can be used for catch up video transmission. The catch up content may be broadcast by a dedicated broadcast channel or a unicast channel. In one aspect, the broadcast channel, the sample channel and the catch up channel are broadcast and/or accessed using the same cellular network, such as WiMAX, LTE, UMB, etc. Using WLAN to transmit the catch up channel can be an alternative. As has been discussed before, different channels (broadcast, unicast) can be used for these purposes. For example, in a WiMAX system, it is possible for the access point to store content for each channel up to a entire group of pictures.

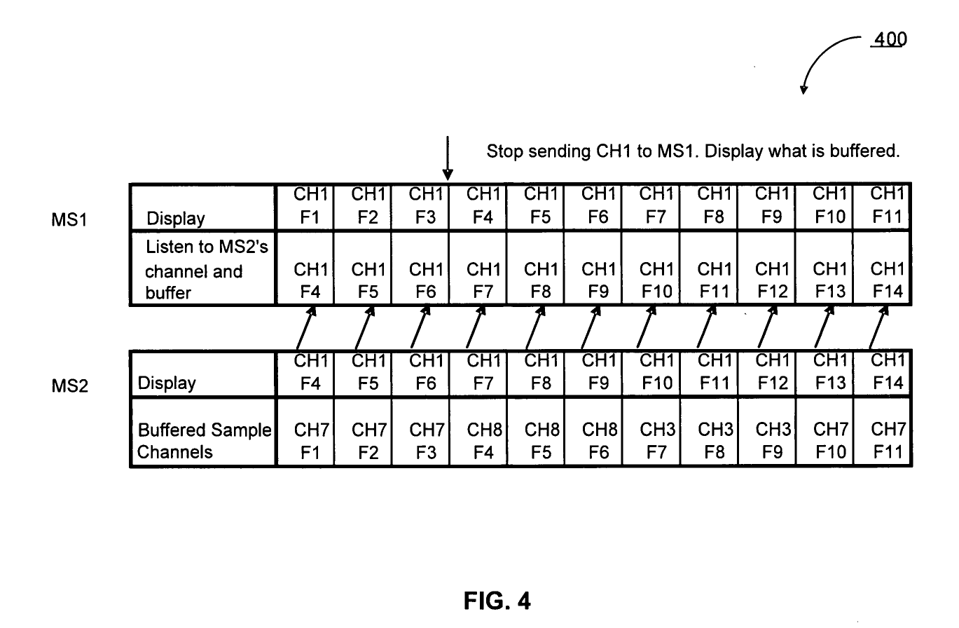

FIG. 4 illustrates a scenario where two handheld devices can be synchronized to use only a single feed of data. For example, consider two handheld devices are viewing the same television channel but are not synchronized with time. The two handheld devices are located within a similar geographic region. In one aspect, the two handheld devices are within the same sector, or communicating with the same cell or radio tower. Rather than relying on two individual connections, and transmitting two sets of data, the two devices can be synchronized such that only a single shared set of data is received by both devices.

Referring the FIG. 4, a first device is viewing channel one, starting at F1. A second device is viewing the same channel, channel one, but is time shifted. While the first device is viewing content from channel one at time interval F1, the second device is viewing content from channel one at time segment F4. In other words, the first device is viewing the same content as the second device, but is delayed in time.

Because the first device is receiving the same data as the second device, but later in time, the first device can simply start listening to the same channel as the second device and buffering the data. Therefore the first device starts receiving data by sharing the connection with the second handset. The content received through the second device's connection is stored in a memory buffer on the first handset. Once enough content has been stored in the memory buffer to cover the time delay existing between the first and second devices, the first device can stop receiving content from its initial connection. The content stored in the memory buffer is now displayed on the first device. The first device continues to receive content through a shared connection with the second device.

This effectively reduces the bandwidth because only one set of data is being sent, as opposed to two sets of data, shifted only by time, one set to each device. Bandwidth is reduced because the network between the devices carries some of the burden.

The above mentioned implementation may be applied to a situation where a first mobile device moves from a first cell to a second cell within a wireless network while watching a specified television channel. Consider a second mobile device exists in the second cell that is also watching the same specified television channel. Therefore, the specified television channel is already being broadcast to the second device within the second cell. The first device could request a second video stream of the specified television channel. However, in one aspect the same video stream may be shard by both the first and second mobile devices. For example, it is likely that the first and second mobile devices are not watching the same channel synchronized in time. In such a case, the mobile device that is watching the specified television channel “later in time” can initially use the sample channel to buffer content from the specified television channel so the target-cell does not have to send two video streams with a time offset.

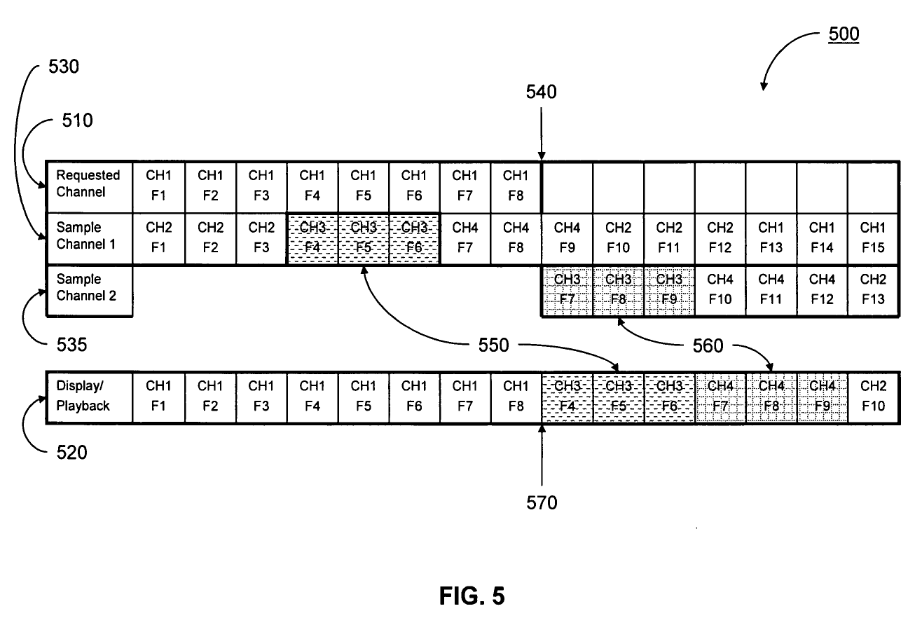

More than one sample channel may be transmitted to the device. FIG. 5 illustrates an implementation wherein more than one sample channel is utilized to implement a scan function.

A scan function on a television typically scans though each of the available television channels, displaying a few seconds of each channel's content before automatically switching to the next. Because the sample channel transmits a plurality of content segments—one for each available channel, the sample channel can effectively provide a scan function to the device. Upon activating the scan function, the device may immediately start to display each of the content segments stored in memory for each of the available channels.

For example, as shown in FIG. 5, the requested channel 510 is initially channel one. Therefore, channel one is also initially shown on the display 520. A first sample channel 530 is received in addition to the requested channel 510. At some point in time, as shown at 540 the subscriber may choose to activate the scan function. Transmission of content from the requested channel 510 is stopped. The scan function is initiated by displaying each of the plurality of content segments stored in memory. For example, content segment 550 contains content from channel one for time interval F4-F6, which was previously received by the sample channel and is stored in memory on the device. Therefore, the scan function may start by immediately displaying content segment 550. The scan function may continue to flip through each of the content segments stored in memory. For example, the next content segment displayed would be the content segment for channel four during time interval F7-F9.

However, at any time the subscriber may cancel the scan function in order to continue viewing the channel being displayed. Therefore, in one aspect a second sample channel is transmitted, such that content will be immediately available, should the subscriber decide to remain on any given channel displayed by the scan function. As shown in FIG. 5, a second sample channel 535 is received. In one aspect the second sample channel 535 is only received selectively, while the first sample channel 530 is received at all times. That is, the second sample channel 535 is only received at certain times, and in this case, the second sample channel 535 is requested upon initiation of the scan function. The second sample channel 535 comprises a plurality of content segments, each content segment comprising content immediately following the content segment from the first sample channel 530. For example, if the first sample channel 530 transmits a content segment 550 from channel three for time interval F4-F6, the second sample channel 535 will transmit a content segment 560 from channel three for time interval F7-F9. Therefore, if a subscriber decides to cancel the scan function, and thereby continue watching content on channel three, the device will have at least one additional content segment 560 immediately available for display via the second sample channel 535.

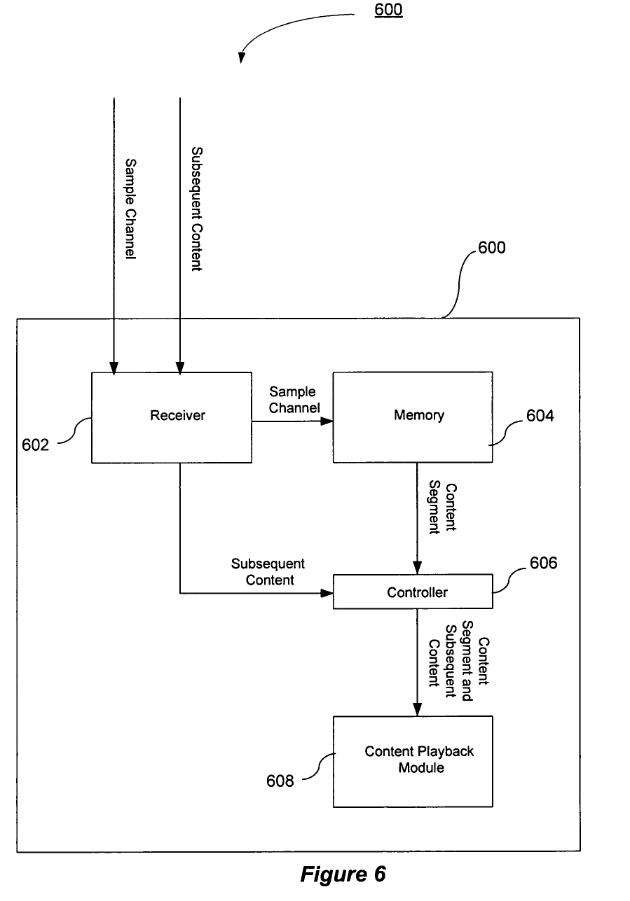

FIG. 6 illustrates an apparatus 600 to which latency of content delivery is reduced. For example, the apparatus 600 may be a mobile phone or a set-top box. The apparatus 600 includes a receiver 602 is configured to receive a sample channel, request subsequent content for the sample channel, and receive the subsequent content for the sample channel. The sample channel is not requested by a subscriber and comprises a plurality of content segments. Each content segment comprises recent content from one of a plurality of channels available for request by the subscriber. The subsequent content starts at or before an endpoint of the content segment. Further, the apparatus 600 includes a memory 604 that is configured to store the plurality of content segments received by the sample channel. In addition, the apparatus 600 includes a controller 606 that detects a request from the subscriber to initiate playback of a specified channel from the plurality of channels and identifies the content segment in memory comprising recent content corresponding to the specified channel. The apparatus 600 also includes a content playback module 608 configured to, upon receiving the subsequent content from the specified channel, initiate playback of the subsequent content such that playback of the subsequent content following the content segment is continuous.

The process shown in FIG. 1 may be implemented in a general, multi-purpose or single purpose processor. Such a processor will execute instructions, either at the assembly, compiled or machine-level, to perform that process. Those instructions can be written by one of ordinary skill in the art following the description of FIG. 1 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Further, the process shown in FIG. 1 may be utilized any time there is not enough capacity to continuously stream and/or a noticeable delay for a user to access content. The process may be utilizes when the last link capacity is constrained relative to the number of channels that a user may want to switch amongst. In an alternative implementation, one or more sample channels may be staggered in time in an effort to give the user more content segments in the machine.

While the apparatus and method have been described in terms of what are presently considered to be the most practical and preferred implementations, it is to be understood that the disclosure need not be limited to the disclosed implementations. It is intended to cover various modifications and similar arrangements included within the spirit and scope of the claims, the scope of which should be accorded the broadest interpretation so as to encompass all such modifications and similar structures. The present disclosure includes any and all implementations of the following claims.

We claim:

1. A method comprising:
receiving a sample channel at a device, the sample channel not being requested by a subscriber and comprising a plurality of content segments, each content segment comprising recent content from one of a plurality of channels available for request by the subscriber;
storing the plurality of content segments in a memory associated with the device;
detecting a request from the subscriber to initiate playback of a specified channel from the plurality of channels;
identifying the content segment in memory comprising recent content corresponding to the specified channel;
initiating playback of the content segment corresponding to the specified channel on the device;
requesting subsequent content for the specified channel, the subsequent content starting at or before an endpoint of the content segment; and
upon receiving the subsequent content from the specified channel, initiating playback of the subsequent content such that playback of the subsequent content following the content segment is continuous.

2. The method of claim 1, wherein the sample channel comprises at least one content segment for each of the plurality of channels available to the subscriber.

3. The method of claim 1, wherein the sample channel comprises a plurality of sets of content segments, each set of content segments comprising one content segment for each channel of the plurality of channels, the sets of content segments being sent over time and comprising content corresponding to a specific time interval.

4. The method of claim 1, wherein a newly received content segment overwrites the content segment corresponding to the same channel previously stored in memory.

5. The method of claim 4, wherein a lookup table is utilized to determine a location of the content segment corresponding to the same channel previously stored in memory.

6. The method of claim 1, wherein playback of the content segment occurs immediately upon request of the specified channel from the subscriber.

7. The method of claim 1, wherein a scan function is implemented by displaying each of the plurality of content segments stored in memory.

8. The method of claim 1, wherein the subsequent content comprises real time content and catch-up content, the real time content being received through a real time broadcast of content from the specified channel, and the catch-up content being received from a secondary channel and extending from a time at or before the end of the content segment to a start of the real time content.

9. The method of claim 12, wherein the sample channel and the real time content are received using a first communications protocol, and the catch up content is received using a second communications protocol that is different from the first communications protocol.

10. A computer program product comprising a computer useable medium having a computer readable program, wherein the computer readable program when executed on a computer causes the computer to:
receive a sample channel at a device, the sample channel not being requested by a subscriber and comprising a plurality of content segments, each content segment comprising recent content from one of a plurality of channels available for request by the subscriber;
store the plurality of content segments in a memory associated with the device;
detect a request from the subscriber to initiate playback of a specified channel;
identify the content segment corresponding to the specified channel in memory;
initiate playback of the content segment corresponding to the specified channel on the device;
request content from the specified channel, the content starting at or before an endpoint of the content segment corresponding to the specified channel; and
upon receiving the content from the specified channel, initiate playback of the content such that the playback of the subsequent content following the content segment is continuous.

11. The computer program product of claim 10, wherein the sample channel comprises one content segment for each of the plurality of channels available to the subscriber.

12. The computer program product of claim 10, wherein the sample channel comprises a plurality of sets of content segments, each set of content segments comprising one content segment for each channel of the plurality of channels, the sets of content segments being sent over time and comprising content corresponding to a specific time interval.

13. The computer program product of claim 10, wherein a newly received content segment overwrites the content segment corresponding to the same channel previously stored in memory.

14. The computer program product of claim 13, wherein a lookup table is utilized to determine a location of the content segment corresponding to the same channel previously stored in memory.

15. The computer program product of claim 10, wherein the subsequent content comprises real time content and catch-up content, the real time content being received through a real time broadcast of content from the specified channel, and the catch-up content being received from a secondary channel and extending from a time at or before the end of the content segment to a start of the real time content.

16. An apparatus comprising:
a receiver configured to receive a sample channel, request subsequent content for the sample channel, and receive the subsequent content for the sample channel, the sample channel not being requested by a subscriber and comprising a plurality of content segments, each content segment comprising recent content from one of a plurality of channels available for request by the subscriber, the subsequent content starting at or before an endpoint of the content segment;
a memory configured to store the plurality of content segments received by the sample channel;
a controller that detects a request from the subscriber to initiate playback of a specified channel from the plurality of channels and identifies the content segment in memory comprising recent content corresponding to the specified channel; and
a content playback module configured to, upon receiving the subsequent content from the specified channel, initiate playback of the subsequent content such that playback of the subsequent content following the content segment is continuous.

17. The apparatus of claim 16, wherein the sample channel comprises one content segment for each of the plurality of channels available to the subscriber.

18. The apparatus of claim 16, wherein the sample channel comprises a plurality of sets of content segments, each set of content segments comprising one content segment for each channel of the plurality of channels, the sets of content segments being sent over time and comprising content corresponding to a specific time interval.

19. The apparatus of claim 16, wherein a newly received content segment overwrites the content segment corresponding to the same channel previously stored in memory.

20. The apparatus of claim 16, wherein a lookup table is utilized to determine a location of the content segment corresponding to the same channel previously stored in memory.
